(19) United States
(12) Patent Application Publication
(10) Pub. No.: US 2019/0069377 A1
(43) Pub. Date: Feb. 28, 2019

(54) Automated Path Prediction for Smart Lighting

(71) Applicant: Daniel Dagang Wang, San Diego, CA (US)

(72) Inventor: Daniel Dagang Wang, San Diego, CA (US)

(21) Appl. No.: 16/028,010

(22) Filed: Jul. 5, 2018

Related U.S. Application Data
(60) Provisional application No. 62/531,287, filed on Jul. 11, 2017.

(51) Int. Cl. H05B 37/02

(52) U.S. Cl. CPC H05B 37/0227; H04W 4/80; H05B 37/0281

(57) ABSTRACT

A method is provided for a lighting node in a lighting system. When the lighting node receives a first notification indicating a first event from a neighboring device, the lighting node updates a local buffer of events with the first event, executes a classifier based on events in the local buffer to calculate a probability of imminent motion, turns on a light in the light node when the probability is greater than a threshold, and starts a timer. When the lighting node detects a movement before the timer expires, the lighting node turns the light on when the light is not already on, sends a second notification indicating a second event, updates the local buffer with the second event, and retrains the classifier with the events in the local buffer to affirm or reject the probability. When the lighting node does not detect movement before the timer expires, the lighting node trains the classifier with the events in the local buffer to affirm or reject the probability.

### FIELD OF THE INVENTION

The present disclosure relates automatic lighting systems for home and office.

### BACKGROUND

An automatic lighting system can make a home or office more welcoming, inviting, and safe by turning on lights in response to signals from motion and entry sensors.

### SUMMARY

A method is provided for a lighting node in a lighting system. When the lighting node receives a first notification indicating a first event from a neighboring device, the lighting node updates a local buffer of events with the first event, executes a classifier based on events in the local buffer to calculate a probability of imminent motion, turns on a light in the light node when the probability is greater than a threshold, and starts a timer. When the lighting node detects a movement before the timer expires, the lighting node turns the light on when the light is not already on, sends a second notification indicating a second event, updates the local buffer with the second event, and retrains the classifier with the events in the local buffer to affirm or reject the probability. When the lighting node does not detect movement before the timer expires, the lighting node trains the classifier with the events in the local buffer to affirm or reject the probability.

### BRIEF DESCRIPTION OF THE DRAWINGS

In the drawings:

FIG. 1 is a block diagram of a lighting node in examples of the present disclosure.

FIG. 2 is a flowchart of a method for the lighting node of FIG. 1 to perform path predication in examples of the present disclosure.

Use of the same reference numbers in different figures indicates similar or identical elements.

### DETAILED DESCRIPTION

A home or office lighting system provides automatic path lighting for its occupants—as the person enters a house or starts to move, the system “predicts” the eventual destination and the likely route. Lights along the predicted path is then turned on ahead of the person for convenience and safety.

A lighting system may rely on a network of motion and entry sensors all connected to a centralized server, either on-site or in the cloud. The server collects, stores and analyze sensor data to come up with system-wide predictions that are then activated via centralized lighting control system.

In examples of the present disclosure, an automatic lighting system includes self-directed lighting units with integrated motion sensor (e.g. infrared sensor) and near-range radio (e.g. Bluetooth). These nodes individually monitor its immediate environment, communicate with its neighbors, and make independent lighting decisions. As a whole, the system is capable of learning and predicting complex behaviors but without the need for a centralized server; all logics are handled locally on each weakly-connected node. The proposed solution has the following advantages.
Low cost—identical hardware and logic in each node means the system can be mass produced at high volume.
Low maintenance—nodes are self-directed and self-correcting so there is no need for centralized configuration or control.
Fault-tolerance & resiliency—without the need for a centralized server, the single point of failure is removed and the system would degrade gracefully even as component nodes fail or are disconnected from the mesh network.
Greater privacy—there is no need for centralized activity logs and motion data never leaves the premise.

Setup

Each light node is equipped with a motion sensor device (e.g. infrared sensor), internal clock and a short-range radio (e.g. Bluetooth). If movement is detected via the motion sensor, the light node will (1) immediately turn on and (2) send event notifications (e.g. Bluetooth advertisements).

At the same time, the light node listens for event notifications from its neighbors. Upon receiving such notifications, the light node may optionally rebroadcast the event notifications in order propagate the event signal. A neighbor may be another lighting node, a motion sensor, or a door sensor. The event notification may indicate a detected motion or an open door.

Each light node will initially have no knowledge of its environment or of the behavior of the human occupants. Over time, the node will learn to anticipate motion event based on combination of factors such as time of day and event notifications from neighbors.

Learn

Each light node maintains a local buffer of recent events, both locally observed (e.g. motion, time and date, temperature, etc.) and relayed via its neighbors. Each entry in the buffer will contain, at a minimal:
1. Event Type
2. Source Node ID—which node first observed the event (could be self)
3. Most Recent Relay Node ID—which node relayed the event (could be self)

As the system operates, whenever a movement is observed via the motion sensor—i.e. when true motion has been detected, the content of the event buffer is “learned” as a possible precursor to the lighting event. Conversely, event history that do not end up with movement are periodically learned as the opposite case. I.e. the light node behaves as a classifier of YES/NO near-future movement based on near-past events.

Make Predictions

Whenever new events are relayed, the light node will update its local buffer of recent events and execute the above classifier to calculate a probability of class membership—i.e. what is the probability that an imminent motion will be detected.

If the predicted probability is above a certain threshold, the light node will turn on its light.

Self-Validate

For every prediction made in the above step, the light node will eventually be able to reconcile the prediction with the actual outcome.

| | Motion Detected | Motion Not Detected |
|---|---|---|
| Motion Predicted | AFFIRM | REJECT |
| Motion Not Predicted | REJECT | AFFIRM |

The classifier is then retrained with the updated results to either AFFIRM or REJECT the validated prediction. Classifier internal weights and coefficients are then adjusted and optimized to maximize predictiveness while reducing false_positives.

This feedback loop can be completely automated and occurs in parallel within each light node, without the need for a central controller.

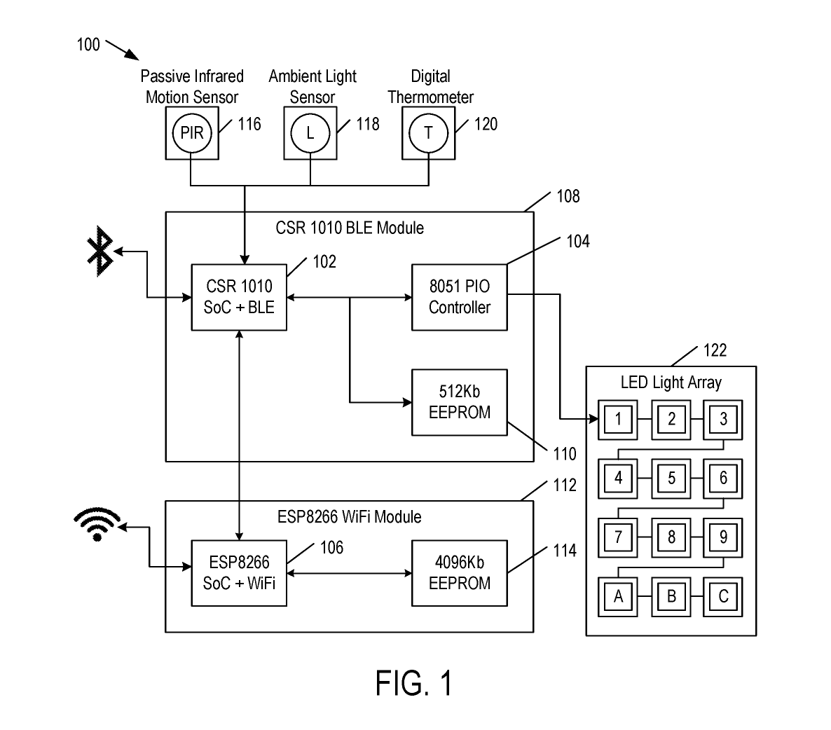

FIG. 1 is a block diagram of a lighting node 100 in examples of the present disclosure. Lighting node 100 includes three microprocessors (MCUs) 102, 104, and 106. MCUs 102 and 104 (e.g., CSR 1010 and Intel 8051) may be located on the same module 108 (e.g., CSR 1010 BLE module) sharing a nonvolatile memory 110 (e.g., an EEPROM). MCU 106 (e.g., ESP8266) is in its own module 112 (e.g., a ESP8266 WiF module) with its own nonvolatile memory 114 (e.g., an EEPROM). Although three MCUs 102, 104, and 106 in two separate modules 108 and 112 are shown, they may be replaced with fewer MCUs in the same or separate modules to perform the same functionalities. Lighting node 100 also includes a motion sensor 116 (e.g., a passive infrared motion sensor), an ambient light sensor 118, a digital thermometer 120, and a LED light array 122.

MCU 102 runs code for most of the core logic, sensor handlers, and path prediction. MCU 102 communicates with other lighting nodes over Bluetooth. MCU 102 is connected to MCU 104, MCC 106, nonvolatile memory 110, motion sensor 116, ambient light sensor 118, and a digital thermometer 120. MCU 104 runs code for handling LED lighting. MCU 104 is connected to nonvolatile memory 110 and LED light array 122. MCU 106 runs code for relaying nearby Bluetooth signals over HTTP connections to a server, which uses the combination of Bluetooth signals received from multiple lighting nodes 100 to calculate the location of a Bluetooth device.

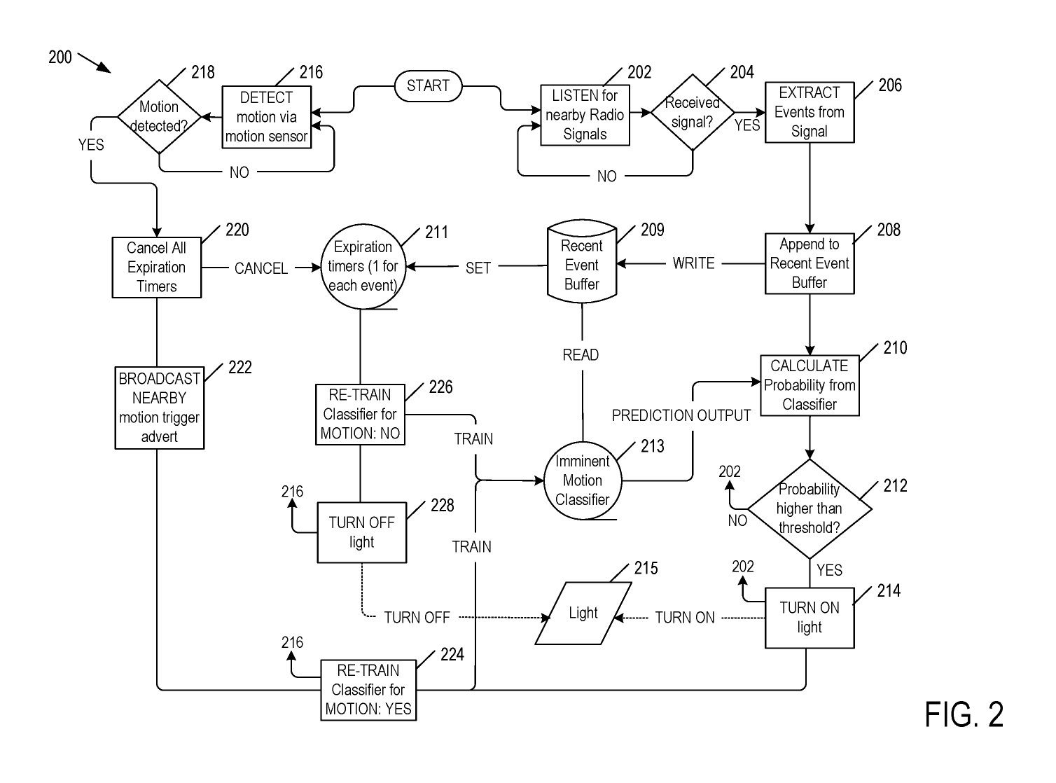

FIG. 2 is a flowchart of a method 200 for lighting node 100 (FIG. 1) to perform path predication in examples of the present disclosure. Method 200 includes three parallel processes.

A first process starts in block 202. In block 202, MCU 102 (FIG. 1) listens for a nearby radio signal. Block 202 may followed by block 204. In block 204, MCU 102 determines if any nearby radio signal has been detected. If no, block 204 may loop back to block 202. If yes, block 204 may be followed by block 206. In block 206, MCU 102 extracts an event from the radio signal. The radio signal may be a nearby motion trigger advertisement from another lighting node 100, a door open trigger advertisement from a door sensor, or another event from another sensor. Block 206 may be followed by block 208. In block 208, MCU 102 appends the event(s) to a recent event buffer 209 in volatile memory. Recent event buffer 209 stores a sufficient number of the most recent events (e.g., 128, 1024, or more) to adequately train an imminent motion classifier 211. MCU 102 also starts an expiration timer 211 for the event. Block 208 may be followed by block 210. In block 210, MCU 102 calculates the probability of imminent motion from the imminent motion classifier 213. Block 210 may be followed by block 212. In block 212, MCU 102 determines if the probability is higher than a threshold. If no, block 212 may loop back to block 202. If yes, block 212 may be followed by block 214. In block 214, MCU 102 turns on a light 215. More specifically, MCU 102 causes MCU 104 (FIG. 1) to activate at least part of LED light array 122 (FIG. 1). Block 214 may loop back to block 202.

A second process starts in block 216. In block 216, MCU 102 detects motions with motion sensor 116 (FIG. 1). Block 216 may be followed by block 218. In block 218, MCU 102 determines if any motion is detected. If no, block 218 may loop back to block 216. If yes, block 218 may be followed by block 220. In block 220, MCU 102 cancels all expiration timers 211. Block 220 may be followed by block 222. In block 222, MCU 102 broadcasts a nearby motion trigger advertisement. Block 222 may be followed by block 224. In block 224, MCU 102 trains the imminent motion classifier 213 to affirm motion that is predicated or reject motion that is not predicted. The imminent motion classifier 213 may not discern between different event types (e.g., detected motion or open door). Block 224 may loop back to block 216.

A third process starts in block 226. In block 226, once an expiration timer expires for an event, MCU 102 retrains the imminent motion classifier 213 to reject motion that is predicated or affirm motion that is not predicted. Block 226 may be followed by block 228. In block 228, MCU 102 turns off light 215. More specifically, MCU 102 causes MCU 104 (FIG. 1) to deactivate at least part of LED light array 122 (FIG. 1). Block 228 may loop back to block 216.

Various other adaptations and combinations of features of the embodiments disclosed are within the scope of the invention. Numerous embodiments are encompassed by the following claims.

1. A method for a lighting node in a lighting system, the method comprising:
when a first notification indicating a first event is received from a neighboring device:
updating a local buffer of events with the first event;
executing a classifier based on events in the local buffer to calculate a probability of imminent motion;
when the probability is above a threshold, turning on a light in the light node; and
starting a timer;
when a movement is detected before the timer expires:
turning the light on when the light is not already on;
sending a second notification indicating a second event;
updating the local buffer with the second event; and
retraining the classifier with the events in the local buffer to affirm or reject the probability; and
when the timer expires before any movement is detected, training the classifier with the events in the local buffer to affirm or reject the probability.

2. The method of claim 1, wherein the neighboring device is another lighting node, a motion sensor, or a door sensor.

3. The method of claim 2, wherein the first event indicates a detected motion or an open door.

4. A lighting node for a lighting system, comprising:
a motion sensor;
a radio;
a memory storing instructions and a buffer of events;
a processor executing the instructions to:
when a first notification indicating a first event is received from a neighboring device:
update the local buffer with the first event;
execute a classifier based on events in the local buffer to calculate a probability of imminent motion;
when the probability is above a threshold, turning on a light in the light node; and
starting a timer;
when the motion sensor detects a movement before the timer expires:
turn the light on when the light is not already on;
send a second notification indicating a second event;
update the local buffer with the second event; and
retrain the classifier with the events in the local buffer to affirm or reject the probability; and
when the timer expires before the motion sensor detects any movement, training the classifier with the events in the local buffer to affirm or reject the probability.

5. The light node of claim 4, wherein the neighboring device is another lighting node, a motion sensor, or a door sensor.

6. The lighting node of claim 5, wherein the first event indicates a detected motion or an open door.
